(19) United States
(12) Patent Application Publication
(10) Pub. No.: US 2025/0168649 A1
(43) Pub. Date: May 22, 2025

(54) Methods And Apparatuses For Multi-Radio Access Technology Spectrum Sharing In Mobile Communications

(71) Applicant: MediaTek Inc., Hsinchu City (TW)

(72) Inventors: Yi-Chia Lo, Hsinchu City (TW); Din-Hwa Huang, Hsinchu City (TW); Cheng-Hsun Li, Hsinchu City (TW); Wei-De Wu, Hsinchu City (TW); Pei-Kai Liao, Hsinchu City (TW)

(21) Appl. No.: 18/901,046

(22) Filed: Sep. 30, 2024

Related U.S. Application Data
(60) Provisional application No. 63/601,862, filed on Nov. 22, 2023.

(51) Int. Cl. H04W 16/14; H04L 5/00; H04W 8/22; H04W 72/1273; H04W 72/231; H04W 74/0833

(52) U.S. Cl. CPC H04W 16/14; H04L 5/0051; H04W 8/22; H04W 72/1273; H04W 72/231; H04W 74/0833

(57) ABSTRACT

Various solutions for multi-radio access technology (RAT) spectrum sharing in mobile communications are described. An apparatus utilizing a first RAT may transmit user equipment (UE) capability information to a first network node of the first RAT, wherein the UE capability information indicates that the apparatus supports multi-RAT spectrum sharing (MRSS). Then, the apparatus may receive a signaling from the first network node, wherein the signaling indicates the apparatus to provide channel information for MRSS. Based on the signaling, the apparatus may perform at least one of the following: (i) transmitting a measurement report of a channel state information-reference signal (CSI-RS) of a second RAT to the first network node; and (ii) transmitting a sounding reference signal (SRS) or a physical random access channel (PRACH) to a second network node of the second RAT.

### CROSS REFERENCE TO RELATED PATENT APPLICATION(S)

The present disclosure is part of a non-provisional application claiming the priority benefit of U.S. Provisional Patent Application No. 63/601,862, filed 22 Nov. 2023, the content of which herein being incorporated by reference in its entirety.

### TECHNICAL FIELD

The present disclosure is generally related to mobile communications and, more particularly, to multi-radio access technology (RAT) spectrum sharing with respect to user equipment (UE) and network node (e.g., base station (BS)) in mobile communications.

### BACKGROUND

Unless otherwise indicated herein, approaches described in this section are not prior art to the claims listed below and are not admitted as prior art by inclusion in this section.

For current network implementations, one BS is operable to provide radio coverage to a specific geographical area using one or more cells to form a radio access network. The BS may support the operations of the cell(s), and each cell may be operable to provide services to mobile phones and other mobile devices within its radio coverage by utilizing at least one RAT. Depending on the 3^{rd} Generation Partnership Project (3GPP) standards, mobile phones and any mobile devices are varyingly known as UE, terminal equipment (TE), mobile stations (MS), or mobile termination (MT), etc. Examples of different RATs include 2^{nd} generation (2G) Global System for Mobile Communications (GSM), 3^{rd} generation (3G) Universal Mobile Telecommunications System (UMTS), 4^{th} generation (4G) Long Term Evolution (LTE), 5^{th} generation (5G) New Radio (NR), beyond 5G (B5G), and 6th Generation (6G).

In 4G-to-5G migration and 4G-5G coexistence, the design of dynamic spectrum sharing (DSS) enables dynamic time-division multiplexing (TDM) or frequency-division multiplexing (FDM) spectrum sharing only, as shown in part (A) of FIG. 1. However, the 4G-5G DSS design may be detrimental to UE throughput and network coverage either in 4G system or 5G system. For example, it is observed that in a network with coexisting 4G and 5G systems, the available resources may become extremely limited with a high (e.g., approximately 53%) overhead as shown in part (B) of FIG. 1. Around 30% of the overhead may come from 4G cyclic prefix (CP), or 25% or more of the overhead may come from 5G CP. As a result, the network may as well downgrade to 4G for resource allocations, since 5G UEs generally support dual mode operation (i.e., support both 4G and 5G). Moreover, the interference in the network would be high, including the interference of 4G cell-specific reference signal (CRS) to 5G UEs, and the interference of 4G physical downlink shared channel (PDSCH) to 5G UEs.

The feature of DSS is also envisioned to be supported in 5G-to-6G migration and 5G-6G coexistence (or renamed multi-RAT spectrum sharing (MRSS)), expectantly with enhancements to improve UE throughput for both 5G and 6G UEs. As the topic is still under study, the design of MRSS for 5G-6G coexistence is not yet defined and it has become an important issue for newly developed wireless communication systems. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to multi-RAT spectrum sharing in mobile communications. It is believed that the above-described issues would be avoided or otherwise alleviated by implementing one or more of the proposed schemes described herein.

In one aspect, a method may involve an apparatus, utilizing a first RAT, transmitting UE capability information to a first network node of the first RAT, wherein the UE capability information indicates that the apparatus supports MRSS. The method may also involve the apparatus receiving a signaling from the first network node, wherein the signaling indicates the apparatus to provide channel information for MRSS. The method may further involve the apparatus performing at least one of the following based on the signaling: (i) transmitting a measurement report of a channel state information-reference signal (CSI-RS) of a second RAT to the first network node; and (ii) transmitting a sounding reference signal (SRS) or a physical random access channel (PRACH) to a second network node of the second RAT.

In one aspect, an apparatus may comprise a transceiver which, during operation, wirelessly communicates with one or more network nodes. The apparatus may also comprise a processor communicatively coupled to the transceiver. The processor, during operation, may perform operations comprising transmitting, via the transceiver, UE capability information to a first network node of the first RAT, wherein the UE capability information indicates that the apparatus supports MRSS. The processor may also perform operations comprising receiving, via the transceiver, a signaling from the first network node, wherein the signaling indicates the apparatus to provide channel information for MRSS. The processor may further perform operations comprising performing, via the transceiver, at least one of the following based on the signaling: (i) transmitting a measurement report of a CSI-RS of a second RAT to the first network node; and (ii) transmitting an SRS or a PRACH to a second network node of the second RAT.

In one aspect, a method may involve a network node, utilizing a first RAT, receiving UE capability information from an apparatus of the first RAT, wherein the UE capability information indicates that the apparatus supports MRSS. The method may also involve the network node transmitting a signaling to the apparatus based on the UE capability information, wherein the signaling indicates the apparatus to provide channel information for MRSS. The method may further involve the network node performing at least one of the following based on the signaling: (i) receiving a measurement report of a CSI-RS of a second RAT from the apparatus; and (ii) receiving, from a second network node of the second RAT, a measurement result of an SRS or a PRACH transmitted from the apparatus to the second network node.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of the DSS design for 4G-5G coexistence.

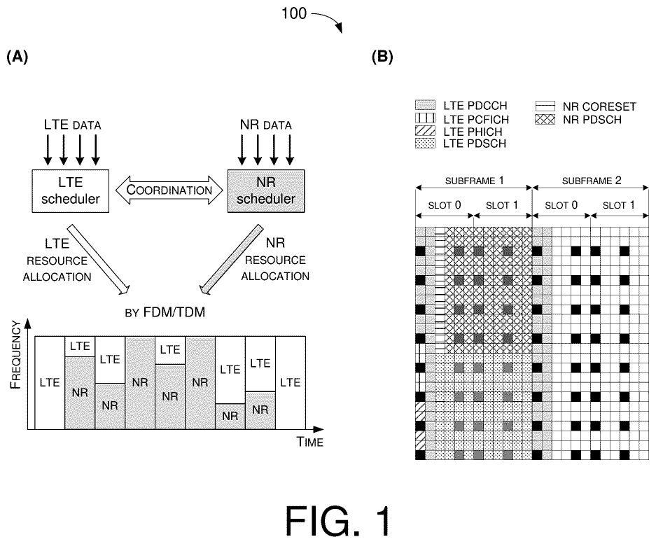

FIG. 2 is a diagram depicting an example scenario of resource allocations for 5G and 6G systems under the single-RAT assumption.

FIG. 3 is a diagram depicting an example scenario of resource allocations for 5G and 6G systems under the multi-RAT assumption.

FIG. 4 is a diagram depicting an example scenario of a communication environment in which various solutions and schemes in accordance with the present disclosure may be implemented.

FIG. 5 is a diagram depicting an example scenario of resource allocations for 5G-6G coexistence without DMRS and CORESET coordination in accordance with an implementation of the present disclosure.

FIG. 6 is a diagram depicting an example scenario of resource allocations for 5G-6G coexistence with DMRS coordination in accordance with an implementation of the present disclosure.

FIG. 7 is a diagram depicting an example scenario of a message sequence chart for multi-RAT spectrum sharing in accordance with an implementation of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to multi-RAT spectrum sharing in mobile communications. According to the present disclosure, a number of possible solutions may be implemented separately or jointly. That is, although these possible solutions may be described below separately, two or more of these possible solutions may be implemented in one combination or another.

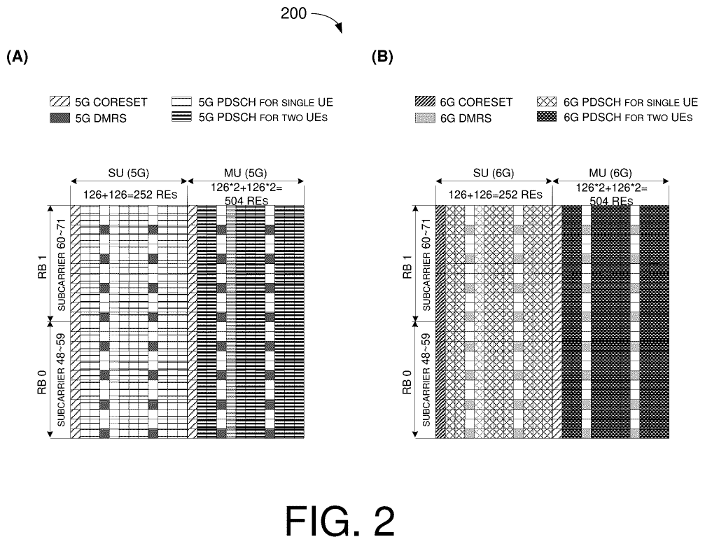

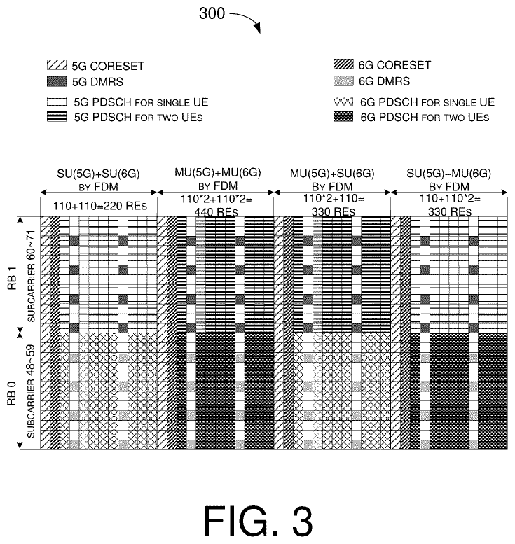

In 5G or 6G system, the overhead and available resources may be calculated as follows. Taking the channel bandwidth of 20 MHz as an example, the overhead is 25% in total without considering the CP length, and the available resource elements (REs) per resource block (RB) is 168*(1−0.25)=126 REs, where 168 (2*84=168) is the total RE number in one RB. Under a single-RAT assumption, the respective overhead ratios of 5G system and 6G system are similar. FIG. 2 illustrates an example scenario 200 of resource allocations for 5G and 6G systems under the single-RAT assumption. Part (A) of FIG. 2 depicts the resource allocations in a solely 5G system, while part (B) of FIG. 2 depicts the resource allocations in a solely 6G system. In scenario 200, SU (single-user) denotes the case of RB(s) scheduled to only one UE, and MU (multi-user) denotes the case of RB(s) scheduled to two UEs (e.g., two 5G UEs or two 6G UEs) that formed an MU pair. Under a multi-RAT assumption, 5G system and 6G system may coexist by FDM and/or TDM. FIG. 3 illustrates an example scenario 300 of resource allocations for 5G and 6G systems under the multi-RAT assumption. As shown in FIG. 3, 5G UE and 6G UE may be scheduled in difference RBs in the same slot. Taking the channel bandwidth of 20 MHz as an example, the available REs per RB is 168*(1−0.25−0.0929)=110 REs, where 168 is the total RE number in one RB.

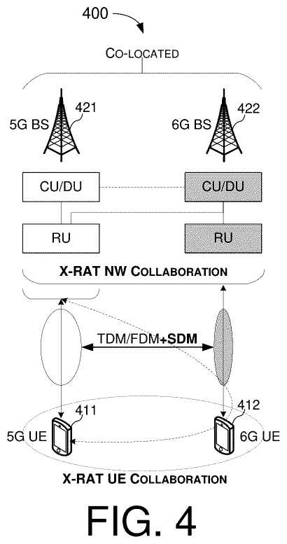

In view of the above, the present disclosure proposes a number of schemes pertaining to multi-RAT spectrum sharing in mobile communications, aiming to enhance UE throughput for 5G-6G coexistence. FIG. 4 illustrates an example scenario 400 of a communication environment in which various solutions and schemes in accordance with the present disclosure may be implemented. Scenario 400 depicts a 5G-6G coexistence network involving a 5G BS 421 (e.g., a next-generation NB (gNB) or a transmission and reception point (TRP)) and a 6G BS 422 co-located with each other to serve a 5G UE 411 and a 6G UE 412. Each of the 5G BS 421 and the 6G BS 422 may include a central unit (CU) or a distributed unit (DU) and a radio unit (RU), and there may be network interfaces connecting the CU/DU/RU of the 5G BS 421 with the CU/DU/RU of the 6G BS 422 for cross-RAT network collaboration (e.g., 5G network may collaborate with 6G network to enhance 6G coverage). In addition, 5G-6G dynamic spectrum sharing using TDM/FDM/SDM is supported to enhance UE throughput for both the 5G UE 411 and the 6G UE 412 (e.g., the 6G UE 412 may use the unused MIMO layers to achieve better performance). In such communication environment, the UEs 411-412 and the BSs 421-422 may implement various schemes pertaining to multi-RAT spectrum sharing in mobile communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

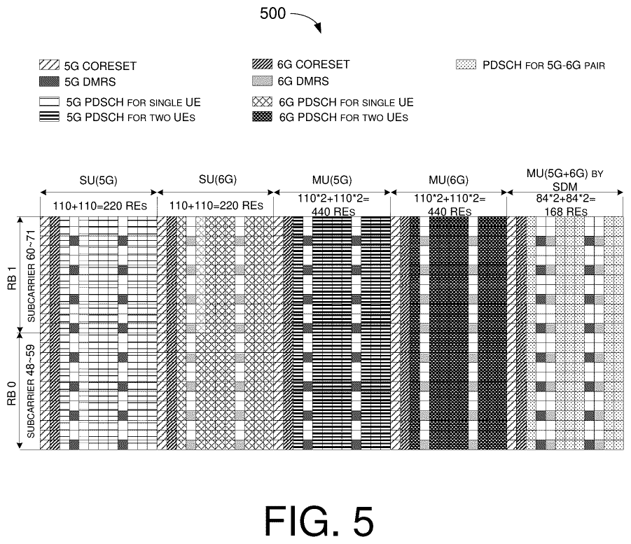

Under certain schemes of the present disclosure, 5G-6G coexistence without DMRS and CORESET coordination is proposed, where a 5G UE and a 6G UE may be scheduled in different RBs if they cannot form an MU pair, or may be scheduled in the same RB if they can form an MU pair. FIG. 5 illustrates an example scenario 500 of resource allocations for 5G-6G coexistence without DMRS and CORESET coordination in accordance with an implementation of the present disclosure. As shown in FIG. 5, for the case where the 5G UE and the 6G UE are scheduled in different RBs, the available REs per RB is 168*(1−0.25−0.0929)=110 REs. For the case where the 5G UE and the 6G UE are scheduled in the same RB, PSDCHs for the 5G UE and the 6G UE are transmitted by space-division multiplexing (SDM) and the available REs per RB is 168*(1−0.5)=84 REs.

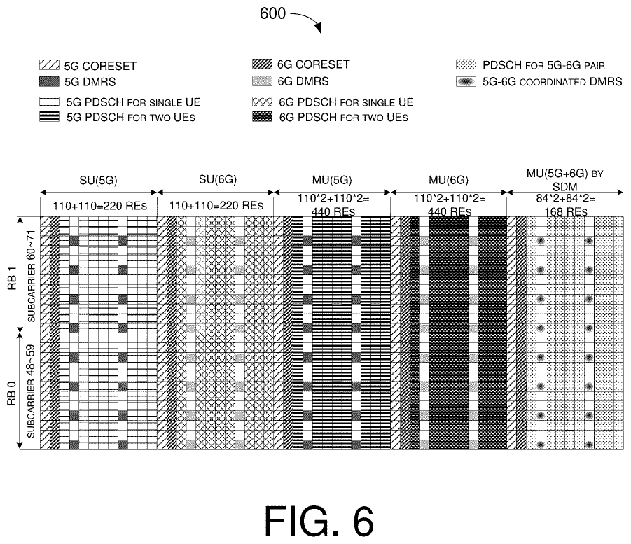

Under certain schemes of the present disclosure, 5G-6G coexistence with DMRS coordination is proposed, where a 5G UE and a 6G UE may be scheduled in different RBs if they cannot form an MU pair, or may be scheduled in the same RB if they can form an MU pair. FIG. 6 illustrates an example scenario 600 of resource allocations for 5G-6G coexistence with DMRS coordination in accordance with an implementation of the present disclosure. As shown in FIG. 6, for the case where the 5G UE and the 6G UE are scheduled in the same RB, PSDCHs for the 5G UE and the 6G UE are transmitted by SDM, 5G-6G DMRS are coordinated, and the available REs per RB is 168*(1-0.25-0.0929)=110 REs.

To realize DMRS coordination, the network side (e.g., a 5G BS and a 6G BS) may collect CSI-RS reporting and/or detect/measure the SRS or PRACH from a 5G UE and 6G UE, such that the 5G BS and the 6G BS may coordinate with each other to determine the MU pair and DMRS port. In some implementations, the 6G BS may receive the CSI-RS report from the 6G UE, and/or detect/measure the SRS/PRACH from the 6G UE. In some implementations, the 5G BS may receive the CSI-RS report from the 5G UE, and/or detect/measure the SRS/PRACH from the 5G UE. In some implementations, the 6G BS may detect/measure the SRS/PRACH from the 5G UE, and/or receive the CSI-RS report from the 5G UE (e.g., through the 5G network). In some implementations, the 5G BS may detect/measure the SRS/PRACH from the 6G UE, and/or receive the CSI-RS report from the 6G UE (e.g., through the 6G network). In some implementations, the 6G BS may collect information for determining the MU pair, and then inform the 5G BS of the MU pair through the network. In some implementations, the 5G BS may collect information for determining the MU pair, and then inform the 6G BS of the MU pair through the network. In some implementations, the MU pair determination may be made by the higher-layer controller, which then informs the 5G BS and the 6G BS. In some implementations, the 5G BS may use 5G DMRS port, and the 6G BS may use new RAT DMRS port. In some implementations, the 6G BS may use 5G DMRS port in 5G-6G MU case, and use new RAT DMRS port in 6G SU case. In some implementations, 6G DMRS may be new RAT DMRS. In some implementations, 6G DMRS may be extended from 5G DMRS (e.g., frequency domain-orthogonal cover code (OCC) length 8 (preclude the 5G FD-OCC length 4)).

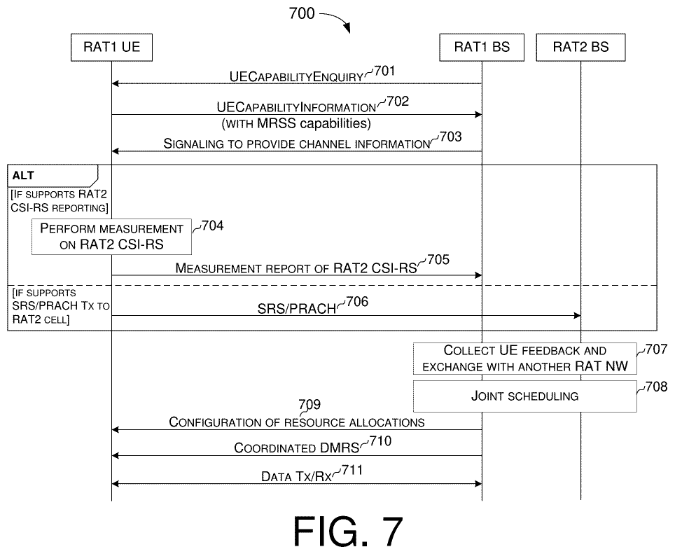

FIG. 7 illustrates an example scenario 700 of a message sequence chart for multi-RAT spectrum sharing in accordance with an implementation of the present disclosure. In step 701, RAT1 (e.g., 5G) BS transmits a UECapabilityEnquiry message to request RAT1 UE to report whether it supports MRSS. In step 702, RAT1 UE responds to the UECapabilityEnquiry message by transmitting a UECapabilityInformation message to RAT1 BS. Specifically, the UECapabilityInformation message includes the MRSS capabilities if the UE supports MRSS. The MRSS capabilities may include at least one of the following: (i) cross-RAT CSI-RS reporting capability; (ii) cross-RAT SRS/PRACH transmission capability; (iii) cross-RAT PDSCH DMRS processing capability; and (iv) cross-RAT PUSCH DMRS processing capability. In some implementations, the cross-RAT CSI-RS reporting capability may include the capability of a RAT1 UE to report the supporting of measurement/reporting based on RAT2 (e.g., 6G) CSI-RS and optionally the corresponding RAT2 CSI-RS processing time, or the capability of a RAT2 UE to report the supporting of measurement/reporting based on RAT1 CSI-RS and optionally the corresponding RAT1 CSI-RS processing time. In some implementations, the cross-RAT SRS/PRACH transmission capability may include the capability of a RAT1 UE to report the supporting of transmitting SRS/PRACH toward RAT2 cell(s) and optionally the corresponding processing time, or the capability of a RAT2 UE to report the supporting of transmitting SRS/PRACH toward RAT1 cell(s) and optionally the corresponding processing time. In some implementations, the cross-RAT PDSCH DMRS processing capability may include the capability of a RAT1 UE to report the supporting of RAT2 PDSCH DMRS and optionally the corresponding RAT2 PDSCH DMRS processing time, or the capability of a RAT2 UE to report the supporting of RAT1 PDSCH DMRS and optionally the corresponding RAT1 PDSCH DMRS processing time. In some implementations, the cross-RAT PUSCH DMRS processing capability may include the capability of a RAT1 UE to report the supporting of RAT2 PUSCH DMRS port and optionally the corresponding RAT2 PUSCH processing time, or the capability of a RAT2 UE to report the supporting of RAT1 PUSCH DMRS port and optionally the corresponding RAT1 PUSCH processing time.

In step 703, based on the reported UE capability, RAT1 BS transmits a signaling to request RAT1 UE to provide channel information. The signaling may be a radio resource control (RRC) message, a medium access control (MAC) control element (CE), or a downlink control information (DCI). In some implementations, the signaling may indicate a RAT1 UE to apply the measurement/reporting of RAT2 CSI-RS and optionally the corresponding RAT2 CSI-RS processing time, or indicate a RAT2 UE to apply the measurement/reporting of RAT1 CSI-RS and optionally the corresponding RAT1 CSI-RS processing time. In some implementations, the signaling may indicate a RAT1 UE to apply the SRS/PRACH transmission toward RAT2 cell(s) and optionally the corresponding processing time, or indicate a RAT2 UE to apply the SRS/PRACH transmission toward RAT1 cell(s) and optionally the corresponding processing time. In some implementations, the signaling may indicate a 5G UE to apply RAT2 PDSCH DMRS and optionally the corresponding RAT2 PDSCH DMRS processing time, or indicate a RAT2 UE to apply RAT1 PDSCH DMRS and optionally the corresponding RAT1 PDSCH DMRS processing time. In some implementations, the signaling may indicate a RAT1 UE to apply RAT2 PUSCH DMRS port and optionally the corresponding RAT2 PUSCH processing time, or indicate a RAT2 UE to apply RAT1 PUSCH DMRS port and optionally the corresponding RAT1 PUSCH processing time.

Next, based on the received signaling, RAT1 UE may perform either one or both of (i) RAT2 CSI-RS reporting, and (ii) SRS/PRACH transmission to RAT2 cell(s). Specifically, for RAT2 CSI-RS reporting, RAT1 UE starts performing measurements on RAT2 CSI-RS (step 704) and then transmits the measurement report of RAT2 CSI-RS to RAT1 BS (step 705). For SRS/PRACH transmission to RAT2 cell(s), RAT1 UE starts transmitting SRS/PRACH to RAT2 BS (step 706). Subsequently, in step 707, RAT1 BS and RAT2 BS collects the UE's feedback of channel information and exchange such information with each other (e.g., through network interfaces). In step 708, RAT1 BS and RAT2 BS performs joint scheduling, including cross-RATs MU pair determination, cross-RATs DMRS port selection, etc. In step 709, RAT1 BS transmits the configuration of resource allocations determined in the joint scheduling (e.g., determined codebook/DMRS port per RB) to RAT1 UE. In step 710, based on the configuration, RAT1 UE receives the coordinated DMRS (i.e., the DMRS is coordinated to be applicable to both RAT1 and RAT2, e.g., by SDM) from RAT1 BS. In general, PDSCH/PUSCH DMRS is a special type of physical layer signal which functions as a reference signal for decoding PDSCH/PUSCH. In step 711, RAT1 UE performs data transmission(s) or reception(s) based on the coordinated DMRS.

### Illustrative Implementations

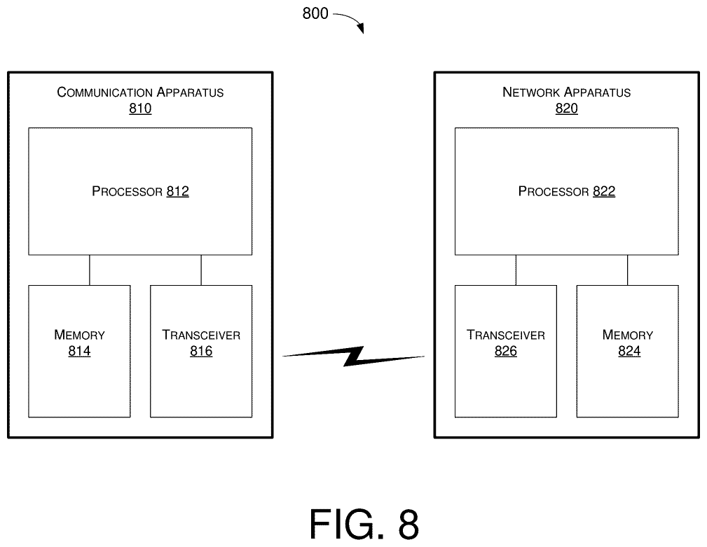

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to multi-RAT spectrum sharing in mobile communications, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 810 may also be a part of a machine type apparatus, which may be a reduced-capability (ReCap) UE, an IoT, NB-IoT, eMTC, IIoT UE such as an immobile or a stationary apparatus, a home apparatus, a roadside unit (RSU), a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of an electronic apparatus, which may be a network node such as a BS (e.g., a gNB, TRP, CU/DU/RU), a small cell, a router or a gateway of a wireless network. For instance, network apparatus 820 may be implemented in a BS in a 5G/6G, IoT, NB-IoT or IIoT network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks, including multi-RAT spectrum sharing, in a device (e.g., as represented by communication apparatus 810) and a network node (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In some implementations, transceiver 816 may be capable of wirelessly communicating with different types of UEs and/or wireless networks of different RATs, such as 5G/B5G/6G. In some implementations, transceiver 816 may be equipped with a plurality of antenna ports (not shown) such as, for example, four antenna ports. That is, transceiver 816 may be equipped with multiple transmit antennas and multiple receive antennas for MIMO wireless communications. In some implementations, network apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications. In some implementations, transceiver 826 may be equipped with a wired network interface such as fiber optic cable for communicating with other network nodes.

In some implementations, communication apparatus 810 may further include a memory 814 coupled to processor 812 and capable of being accessed by processor 812 and storing data therein. In some implementations, network apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 810 and network apparatus 820 may be a communication entity capable of communicating with each other using various proposed schemes in accordance with the present disclosure. For illustrative purposes and without limitation, a description of capabilities of communication apparatus 810, as a UE, and network apparatus 820, as a network node (e.g., a BS), is provided below with processes 900 and 1000.

### Illustrative Processes

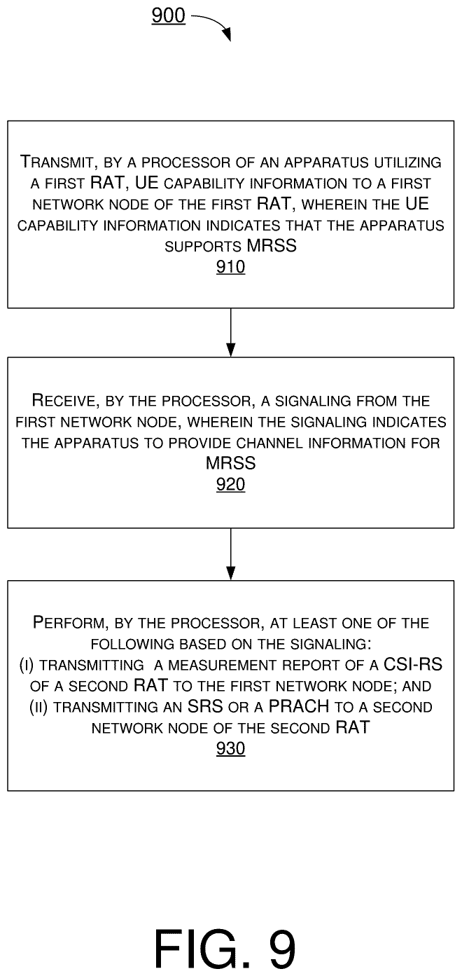

FIG. 9 illustrates an example process 900 in accordance with an implementation of the present disclosure. Process 900 may be an example implementation of above scenarios/schemes, whether partially or completely, with respect to multi-RAT spectrum sharing in mobile communications. Process 900 may represent an aspect of implementation of features of communication apparatus 810. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810 or any suitable UE or machine type devices. Solely for illustrative purposes and without limitation, process 900 is described below in the context of communication apparatus 810. Process 900 may begin at block 910.

At block 910, process 900 may involve processor 812 of communication apparatus 810 utilizing a first RAT, transmitting, via transceiver 816, UE capability information to a first network node (e.g., network apparatus 820) of the first RAT, wherein the UE capability information indicates that communication apparatus 810 supports MRSS. Process 900 may proceed from block 910 to block 920.

At block 920, process 900 may involve processor 812 receiving, via transceiver 816, a signaling from the first network node, wherein the signaling indicates communication apparatus 810 to provide channel information for MRSS. Process 900 may proceed from block 920 to block 930.

At block 930, process 900 may involve processor 812 performing at least one of the following based on the signaling: (i) transmitting a measurement report of a CSI-RS of a second RAT to the first network node; and (ii) transmitting an SRS or a PRACH to a second network node of the second RAT.

In some implementations, the UE capability information may include at least one of the following: (i) an indication of whether communication apparatus 810 supports measurement reporting based on the CSI-RS of the second RAT; (ii) an indication of whether communication apparatus 810 supports processing time corresponding to the CSI-RS of the second RAT; (iii) an indication of whether communication apparatus 810 supports a DMRS of the second RAT; (iv) an indication of whether communication apparatus 810 supports processing time corresponding to the DMRS of the second RAT; (v) an indication of whether communication apparatus 810 supports transmitting the SRS or the PRACH to a cell of the second RAT; and (vi) an indication of whether communication apparatus 810 supports processing time corresponding to the transmission of the SRS or the PRACH to the cell of the second RAT.

In some implementations, process 900 may further involve processor 812 receiving, via transceiver 816, a configuration of an RB scheduled for communication apparatus 810 of the first RAT and another apparatus of the second RAT from the first network node, wherein the RB comprises a DMRS common for both the apparatuses. Additionally, process 900 may further involve processor 812 receiving, via transceiver 816, the DMRS based on the configuration, and performing, via transceiver 816, a transmission or reception to or from the first network node based on the DMRS.

In some implementations, the DMRS may include a 5G DMRS in an event that the first RAT and the second RAT comprise a 5G RAT and a 6^{th} 6G RAT.

In some implementations, the RB may include a PDSCH transmitted for the first RAT and the second RAT by SDM.

In some implementations, the signaling may include an RRC message, a MAC CE, or a DCI.

In some implementations, the first network node and the second network node may be co-located or connected for cross-RAT network collaboration.

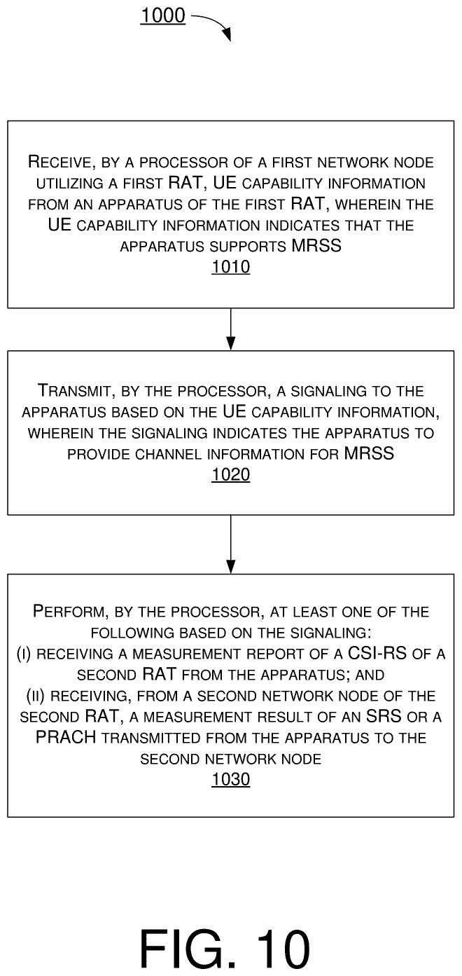

FIG. 10 illustrates an example process 1000 in accordance with an implementation of the present disclosure. Process 1000 may be an example implementation of above scenarios/schemes, whether partially or completely, with respect to multi-RAT spectrum sharing in mobile communications. Process 1000 may represent an aspect of implementation of features of network apparatus 820. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820 or any suitable network node. Solely for illustrative purposes and without limitation, process 1000 is described below in the context of network apparatus 820. Process 1000 may begin at block 1010.

At block 1010, process 1000 may involve processor 822 of network apparatus 820 utilizing a first RAT, receiving, via transceiver 826, UE capability information from communication apparatus 810 of the first RAT, wherein the UE capability information indicates that communication apparatus 810 supports MRSS. Process 1000 may proceed from block 1010 to block 1020.

At block 1020, process 1000 may involve processor 822 transmitting, via transceiver 826, a signaling to communication apparatus 810 based on the UE capability information, wherein the signaling indicates communication apparatus 810 to provide channel information for MRSS. Process 1000 may proceed from block 1020 to block 1030.

At block 1030, process 1000 may involve processor 822 performing at least one of the following based on the signaling: (i) receiving a measurement report of a CSI-RS of a second RAT from communication apparatus 810; and (ii) receiving, from a second network node of the second RAT, a measurement result of an SRS or a PRACH transmitted from communication apparatus 810 to the second network node.

In some implementations, the UE capability information may include at least one of the following: (i) an indication of whether communication apparatus 810 supports measurement reporting based on the CSI-RS of the second RAT; (ii) an indication of whether communication apparatus 810 supports processing time corresponding to the CSI-RS of the second RAT; (iii) an indication of whether communication apparatus 810 supports a DMRS of the second RAT; (iv) an indication of whether communication apparatus 810 supports processing time corresponding to the DMRS of the second RAT; (v) an indication of whether communication apparatus 810 supports transmitting the SRS or the PRACH to a cell of the second RAT; and (vi) an indication of whether communication apparatus 810 supports processing time corresponding to the transmission of the SRS or the PRACH to the cell of the second RAT.

In some implementations, process 1000 may further involve processor 822 determining a configuration of an RB scheduled for communication apparatus 810 of the first RAT and another apparatus of the second RAT based on the measurement report of the CSI-RS of the second RAT and the measurement result of the SRS or the PRACH, wherein the RB comprises a DMRS common for both the apparatuses. Additionally, process 1000 may further involve processor 822 transmitting, via transceiver 826, the configuration of the RB to communication apparatus 810, transmitting, by the processor, the DMRS to communication apparatus 810 based on the configuration, and performing, via transceiver 826, a transmission or reception to or from communication apparatus 810 based on the DMRS.

In some implementations, process 1000 may further involve processor 822 forwarding, via transceiver 826, the measurement report of the CSI-RS of the second RAT to the second network node. Additionally, or optionally, process 1000 may further involve processor 822 forwarding, via transceiver 826, the configuration of the RB to the second network node.

In some implementations, the DMRS may include a 5G DMRS in an event that the first RAT and the second RAT comprise a 5G RAT and a 6G RAT.

In some implementations, the RB may include a PDSCH which is transmitted for the first RAT and the second RAT by SDM.

In some implementations, the signaling may include an RRC message, a MAC CE, or a DCI, and/or the first network node and the second network node may be co-located or connected for cross-RAT network collaboration.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus utilizing a first radio access technology (RAT), user equipment (UE) capability information to a first network node of the first RAT, wherein the UE capability information indicates that the apparatus supports multi-RAT spectrum sharing (MRSS);
receiving, by the processor, a signaling from the first network node, wherein the signaling indicates the apparatus to provide channel information for MRSS; and
performing, by the processor, at least one of the following based on the signaling:
transmitting a measurement report of a channel state information-reference signal (CSI-RS) of a second RAT to the first network node; and
transmitting a sounding reference signal (SRS) or a physical random access channel (PRACH) to a second network node of the second RAT.

2. The method of claim 1, wherein the UE capability information comprises at least one of the following:
an indication of whether the apparatus supports measurement reporting based on the CSI-RS of the second RAT;
an indication of whether the apparatus supports processing time corresponding to the CSI-RS of the second RAT;
an indication of whether the apparatus supports a demodulation reference signal (DMRS) of the second RAT;
an indication of whether the apparatus supports processing time corresponding to the DMRS of the second RAT;
an indication of whether the apparatus supports transmitting the SRS or the PRACH to a cell of the second RAT; and
an indication of whether the apparatus supports processing time corresponding to the transmission of the SRS or the PRACH to the cell of the second RAT.

3. The method of claim 1, further comprising:
receiving, by the processor, a configuration of a resource block (RB) scheduled for the apparatus of the first RAT and another apparatus of the second RAT from the first network node, wherein the RB comprises a DMRS common for both the apparatuses;
receiving, by the processor, the DMRS based on the configuration; and
performing, by the processor, a transmission or reception to or from the first network node based on the DMRS.

4. The method of claim 3, wherein the DMRS comprises a 5^{th} generation (5G) DMRS in an event that the first RAT and the second RAT comprise a 5G RAT and a 6^{th} generation (6G) RAT.

5. The method of claim 3, wherein the RB comprises a physical downlink shared channel (PDSCH) transmitted for the first RAT and the second RAT by space-division multiplexing (SDM).

6. The method of claim 1, wherein the signaling comprises a radio resource control (RRC) message, a medium access control (MAC) control element (CE), or a downlink control information (DCI).

7. The method of claim 1, wherein the first network node and the second network node are co-located or connected for cross-RAT network collaboration.

8. An apparatus, utilizing a first radio access technology (RAT), comprising:
a transceiver which, during operation, wirelessly communicates with one or more network nodes; and
a processor communicatively coupled to the transceiver such that, during operation, the processor performs operations comprising:
transmitting, via the transceiver, user equipment (UE) capability information to a first network node of the first RAT, wherein the UE capability information indicates that the apparatus supports multi-RAT spectrum sharing (MRSS);
receiving, via the transceiver, a signaling from the first network node, wherein the signaling indicates the apparatus to provide channel information for MRSS; and
performing, via the transceiver, at least one of the following based on the signaling:
transmitting a measurement report of a channel state information-reference signal (CSI-RS) of a second RAT to the first network node; and
transmitting a sounding reference signal (SRS) or a physical random access channel (PRACH) to a second network node of the second RAT.

9. The apparatus of claim 8, wherein the UE capability information comprises at least one of the following:
an indication of whether the apparatus supports measurement reporting based on the CSI-RS of the second RAT;
an indication of whether the apparatus supports processing time corresponding to the CSI-RS of the second RAT;
an indication of whether the apparatus supports a demodulation reference signal (DMRS) of the second RAT;
an indication of whether the apparatus supports processing time corresponding to the DMRS of the second RAT;
an indication of whether the apparatus supports transmitting the SRS or the PRACH to a cell of the second RAT; and
an indication of whether the apparatus supports processing time corresponding to the transmission of the SRS or the PRACH to the cell of the second RAT.

10. The apparatus of claim 8, wherein, during operation, the processor further performs operations comprising:
receiving, via the transceiver, a configuration of a resource block (RB) scheduled for the apparatus of the first RAT and another apparatus of the second RAT from the first network node, wherein the RB comprises a DMRS common for both the apparatuses;
receiving, by the processor, the DMRS based on the configuration; and
performing, by the processor, a transmission or reception to or from the first network node based on the DMRS.

11. The apparatus of claim 10, wherein the DMRS comprises a 5^{th} generation (5G) DMRS in an event that the first RAT and the second RAT comprise a 5G RAT and a 6^{th} generation (6G) RAT.

12. The apparatus of claim 10, wherein the RB comprises a physical downlink shared channel (PDSCH) which is transmitted for the first RAT and the second RAT by space-division multiplexing (SDM).

13. The apparatus of claim 8, wherein the signaling comprises a radio resource control (RRC) message, a medium access control (MAC) control element (CE), or a downlink control information (DCI); or wherein the first network node and the second network node are co-located or connected for cross-RAT network collaboration.

14. A method, comprising:
receiving, by a processor of a first network node utilizing a first radio access technology (RAT), user equipment (UE) capability information from an apparatus of the first RAT, wherein the UE capability information indicates that the apparatus supports multi-RAT spectrum sharing (MRSS);
transmitting, by the processor, a signaling to the apparatus based on the UE capability information, wherein the signaling indicates the apparatus to provide channel information for MRSS; and
performing, by the processor, at least one of the following based on the signaling:
receiving a measurement report of a channel state information-reference signal (CSI-RS) of a second RAT from the apparatus; and
receiving, from a second network node of the second RAT, a measurement result of a sounding reference signal (SRS) or a physical random access channel (PRACH) transmitted from the apparatus to the second network node.

15. The method of claim 14, wherein the UE capability information comprises at least one of the following:
an indication of whether the apparatus supports measurement reporting based on the CSI-RS of the second RAT;
an indication of whether the apparatus supports processing time corresponding to the CSI-RS of the second RAT;
an indication of whether the apparatus supports a demodulation reference signal (DMRS) of the second RAT;
an indication of whether the apparatus supports processing time corresponding to the DMRS of the second RAT;
an indication of whether the apparatus supports transmitting the SRS or the PRACH to a cell of the second RAT; and
an indication of whether the apparatus supports processing time corresponding to the transmission of the SRS or the PRACH to the cell of the second RAT.

16. The method of claim 14, further comprising:
determining, by the processor, a configuration of a resource block (RB) scheduled for the apparatus of the first RAT and another apparatus of the second RAT based on the measurement report of the CSI-RS of the second RAT and the measurement result of the SRS or the PRACH, wherein the RB comprises a DMRS common for both the apparatuses;
transmitting, by the processor, the configuration of the RB to the apparatus;
transmitting, by the processor, the DMRS to the apparatus based on the configuration; and
performing, by the processor, a transmission or reception to or from the apparatus based on the DMRS.

17. The method of claim 16, further comprising:
forwarding, by the processor, the measurement report of the CSI-RS of the second RAT to the second network node; or
forwarding, by the processor, the configuration of the RB to the second network node.

18. The method of claim 16, wherein the DMRS comprises a 5^{th} generation (5G) DMRS in an event that the first RAT and the second RAT comprise a 5G RAT and a 6^{th} generation (6G) RAT.

19. The method of claim 16, wherein the RB comprises a physical downlink shared channel (PDSCH) which is transmitted for the first RAT and the second RAT by space-division multiplexing (SDM).

20. The method of claim 14, wherein the signaling comprises a radio resource control (RRC) message, a medium access control (MAC) control element (CE), or a downlink control information (DCI); or wherein the first network node and the second network node are co-located or connected for cross-RAT network collaboration.
